(19) United States
(12) Patent Application Publication
(10) Pub. No.: US 2005/0235228 A1
(43) Pub. Date: Oct. 20, 2005

(54) Presentation device and display method

(75) Inventors: Susumu Hashimoto, Mizuho-ku (JP); Mikihiro Kojima, Anjo (JP)

Correspondence Address: OSTROLENK FABER GERB & SOFFEN, 1180 AVENUE OF THE AMERICAS, NEW YORK, NY, 100368403, US

(73) Assignee: Elmo Company, Limited

(21) Appl. No.: 11/023,077

(22) Filed: Dec. 27, 2004

(30) Foreign Application Priority Data
Apr. 20, 2004 (JP) 2004-124329

(51) Int. Cl. G06F 3/00

(52) U.S. Cl. 715/856

(57) ABSTRACT

When the presentation device receives selection of a pointing marker PM from the OSD, the pointing marker PM is displayed at the same location as the mouse cursor MC. When a left click operation is performed with the mouse at any location on the screen, the pointing marker is disposed fixed at that location. Once a pointing marker has been placed, if a left click on the pointing marker is detected, it can be moved freely. With such a presentation device, even if the mouse cursor MC is moved, since any location on the image can continue to be pointed to by the pointing marker, the presentation can be carried out favorably.

### BACKGROUND OF THE INVENTION

1. Field of the Invention

The present invention relates to a presentation device that uses a camera to record materials such as a document and samples and generates an image, which image can then be displayed on an external monitor or the like.

2. Description of the Related Art

Presentation devices are used for on-site presentations and the like. Models in recent years allow a mouse or other pointing device to be connected. A cursor that, in association with control of the pointing device, moves over an image taken by the camera and being shown on the monitor is also displayed. By moving the cursor, a user is able to easily indicate any location on an image being shown on the monitor.

More recent models of presentation devices also allow various settings that use OSD (on-screen display) to be made (see Unexamined Patent Application 2002-281467A, for example). Using OSD, via a graphical user interface displayed on the monitor the user is able to make various settings of the presentation device, such as hue or camera adjustments. The pointing device mentioned above is used for these OSD operations as well.

However, there exists a risk that if the cursor is moved in order to perform an OSD operation, the cursor will move away from the location on the document that was being indicated previously, thereby impeding smooth progression of the presentation.

### SUMMARY OF THE INVENTION

With the foregoing in view, it is an object of the present invention to provide a presentation device that is optimal for carrying out presentations.

In order to achieve the stated object, the presentation device of the invention comprises the following arrangement. Specifically, it is a device for displaying, on a connected display device, an image created by recording materials. The presentation device comprises operation detecting unit that detects operation of a pointing device intended to point to any particular location on an image displayed on the display device, cursor display unit that displays on the image a cursor that moves in response to movement of the pointing device, and marker positioning unit that, on the basis of a predetermined operation performed at a location being pointed to by the cursor on the image, positions a stationary predetermined marker of predetermined form.

In response to a predetermined operation, the presentation device of the invention positions a stationary predetermined marker at the location of the cursor on the image. Thus, if the cursor is subsequently moved after a marker has been placed, since the marker points to a fixed location, a presentation can be carried out in optimal fashion. The predetermined operation may consist, for example, of operating a button provided on the pointing device, or operating a button provided on the presentation device. In the arrangement hereinabove, the pointing device may consist, for example, of a mouse or tablet, a digitizer, a trackball, a joystick, a remote control equipped with a 10-key, or any of various other types of input devices.

The cursor display unit may also display said marker together with said moving cursor, until said predetermined operation is detected. By so doing, positioning of the marker can be carried out while visually observing the location pointed to by it, making it possible to easily position the marker. It can also be clearly shown that the current operation is a marker positioning operation.

The marker positioning unit may also delete said positioned marker, on the basis of a specified operation. By so doing, the initially positioned marker can be deleted, and the marker positioned at another location. The specified operation for deleting the cursor may consist, for example, of moving the cursor to the marker location, and with the cursor positioned thereon, depressing a button provided on the pointing device or on the presentation device; depressing a button for marker deletion provided in the OSD; or any of various other modes of operation.

The marker positioning unit may also comprise marker selecting unit that, prior to positioning of said marker, selects said predetermined marker from among a plurality of markers of different types prepared in advance. By means of such an arrangement, different markers can be used according to particular applications. Here, possible style differences are differences in appearance, shape, pattern, or in various other elements. By way of appearance, markers of various different colors could be prepared in advance, using markers depending on the color of the materials being displayed on the monitor. By way of shape, markers of various different sizes could be prepared in advance, using markers depending on the size of the area pointed to on the materials being displayed on the monitor.

The marker positioning unit could also position said marker by changing the color of a predetermined area in the image that includes the location pointed to by said cursor, to a color different from that of other areas. By means of this arrangement, it is possible, for example, to employ a mode wherein the area indicated by the cursor is highlighted, while other areas are made darker. Where such an embodiment is employed, it is possible to make any area of an image stand out in the display. Conversely, it would also be possible to make the area indicated by the cursor darker while making other areas lighter. Other embodiments, such as displaying the area indicated by the cursor in color while displaying other areas in black and white or sepia tone would also be possible.

The various embodiments described hereinabove may be implemented in combination or omitted in part, as appropriate. The invention could also be provided as a display method for displaying predetermined markers on images in a presentation device, a computer program for displaying predetermined markers on images, or the like. The various embodiments mentioned above can be implemented regardless of arrangement. The computer program may be recorded on a computer-readable recording medium. Recording media include, for example, flexible disks, compact discs, digital versatile disks, magneto-optical disks, memory cards, hard disks, and any of various other media.

### BRIEF DESCRIPTION OF THE DRAWINGS

FIG. 1 is an illustration showing a simplified arrangement of a document presentation device 10.

FIG. 2 is an illustration showing an example of an image displayed on a display device 18.

FIG. 3 is a block diagram of a control circuit 100 disposed inside the document presentation device 10.

FIG. 4 is an illustration showing an OSD that organizes functions for carrying out camera-related adjustments.

FIG. 5 is an illustration showing an OSD that organizes functions relating to control of lighting and to image processing.

FIG. 6 is an illustration showing an OSD that organizes functions for carrying out drawing of graphics and positioning of pointing markers.

FIG. 7 is an illustration showing an OSD that organizes functions for saving settings of the document presentation device 10.

FIG. 8 is an illustration showing an OSD that organizes functions for saving images.

FIG. 9 is an illustration showing the procedure for displaying a mouse cursor MC and an OSD.

FIG. 10 is a flowchart of the process executed by a microcomputer 170 during positioning of a pointing marker.

FIG. 11 is an illustration showing a mode in which the color surrounding the location where the pointing marker is to be positioned is made different from the color of other areas.

### DESCRIPTION OF THE PREFERRED EMBODIMENTS

The following description of the embodiments of the invention on the basis of working examples shall be made in the order indicated below.

A. Simplified Arrangement of Document Presentation Device:

B. Internal Arrangement of Document Presentation Device:

C. OSD Modes:

D. Mouse Cursor and OSD Display Procedure:

E. Pointing Marker Positioning Process:

A. Simplified Arrangement of Document Presentation Device:

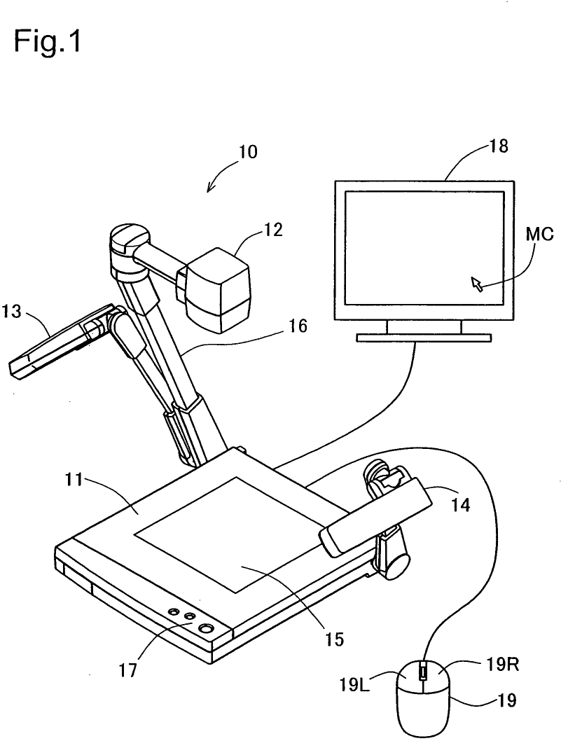

FIG. 1 is an illustration showing a simplified arrangement of a document presentation device 10. The document presentation device 10 comprises a document stand 11 which occupies most of the bottom portion of the device; a camera head 12 facing it; and left and right lights 13, 14 for presentation illumination of the document stand 11 from above. The lights 13, 14 are rotatably connected at the left and right sides of the back edge of the document stand 11, and if necessary can also used when recording a document on the document stand 11. The upper surface of the document stand is formed of light-transmitting material, and has a light 15 housed therein. This light 15 is used when illuminating from below a negative or the like that has been placed on the document stand 11.

A control panel 17 is disposed at the front edge of the document stand 11. On the control panel are disposed a power button, On/Off buttons for the lights 13, 14, 15, buttons for zooming the camera head 12 and for adjusting the focus and iris, buttons for switching the image output device, or various other control buttons.

The camera head 12 is supported on an arm 16 so as to face the generally central portion of the document stand 11, and is used to record various documents placed on the document stand 11. The camera head 12 comprises a CCD (charge-coupled device), and a focusing lens or zoom lens for focusing light onto the CCD; it additionally comprises a control motor for moving the position of the lens on the optical axis, and an iris adjusting mechanism for adjusting the iris. The CCD converts light focused by the lens into an image signal, and this image signal is then output to a control circuit provided within the document stand 11. The control circuit carries out image processing of various kinds such as frame rate conversion, whereupon it output this image signal to a display device 18 connected to the document presentation device 10. As the display device there may be employed, for example, a CRT, liquid crystal display, projector, television, or the like.

The document presentation device 10 has a mouse 19 connected to it as a pointing device. The mouse 19 has a left button 19L and a right button 19R. In the description hereinbelow, pressing the left button 19L shall be termed “left clicking.” When the user operates the mouse 19 by moving it, the mouse cursor MC which moves in association with this operation is displayed on the display device 18, shown superimposed on the image captured by the camera head 12. By using the mouse 19, the user is able to perform OSD (on-screen display) operations, and to point to any location in the image displayed on the display device 18. While in this working example a mouse 19 is connected as the pointing device, there could instead be employed a tablet or digitizer, a trackball, joystick, remote control equipped with a 10-key, or any of various other types of input devices, as the pointing device.

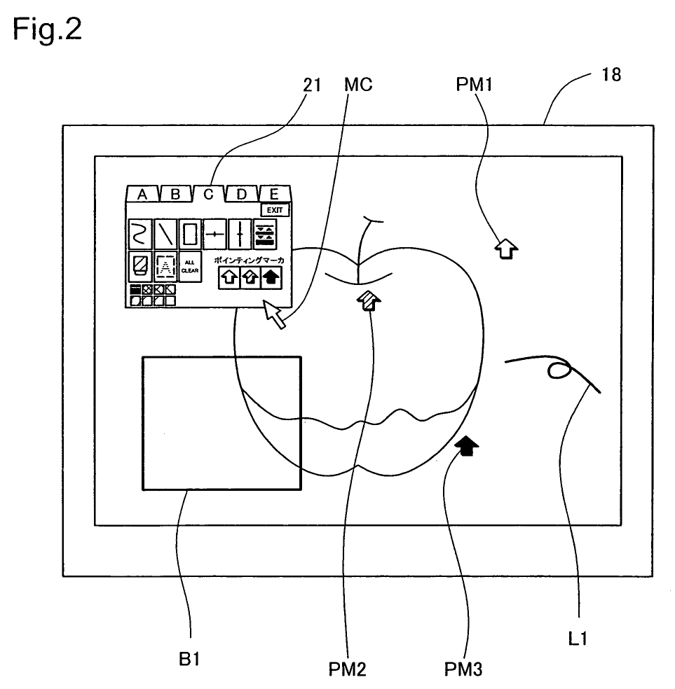

FIG. 2 is an illustration showing an example of an image displayed on a display device 18. In this example the document is an image recording an apple. The image of the apple captured by the camera head 12 is displayed on the display device 18, with a mouse cursor MC, an OSD 21, and pointing markers PM1-PM3 being shown superimposed on the image. The pointing markers PM1-PM3 are markers that may be positioned in order to point to any locations on the image.

The OSD 21 is a graphical user interface for making various settings and performing various operations on the document presentation device 10. The OSD-21 has a number of tabs A-E, with various control buttons being arranged on each tab. Using the OSD 21, the user can position the pointing markers PM1-PM3, as well as draw various shapes on the image, such as a square B1 or a line L1.

B. Internal Arrangement of Document Presentation Device:

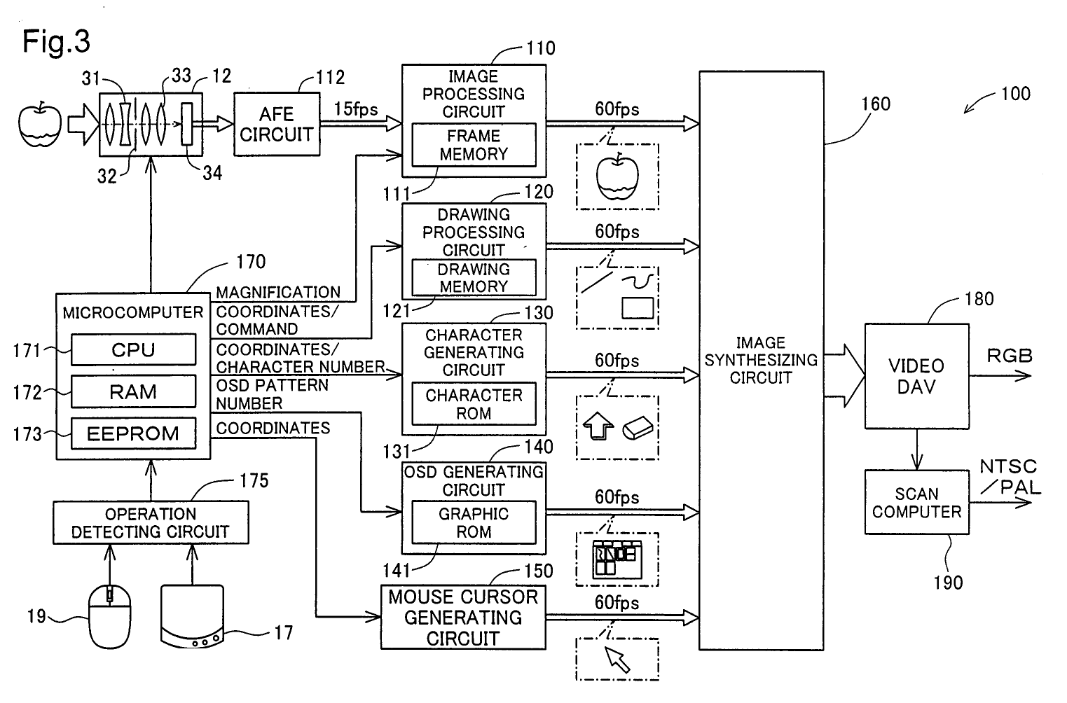

FIG. 3 is a block diagram of a control circuit 100 disposed inside the document presentation device 10. The control circuit 100 comprises an image processing circuit 110 for carrying out image processing of various kinds on images input from the camera head 12, a drawing processing circuit 120 for carrying out drawing on images, a character generating circuit 130 for displaying the pointing markers and the like, and a mouse cursor generating circuit 150 for displaying the mouse cursor MC. Also provided are an image synthesizing circuit 160 for synthesizing images for output to the above circuits, and a microcomputer 170 that controls all operations of the document presentation device 10.

The microcomputer 170 comprises a CPU 171, RAM 172, and EEPROM 173; a program for controlling the camera head 12 and the circuits mentioned above are stored in the EEPROM 173. The CPU 171 executes the program while using the RAM 172 as the work area. The RAM 172 is also used for temporary storage of images output by the image processing circuit 110; the EEPROM 173 is also used for non-volatile storage of various parameters set through the OSD 21.

The mouse 19 and the control panel 17 are connected to the microcomputer 170 via an operation detecting circuit 175. The microcomputer 170, using the operation detecting circuit 175, detects the amount of movement of the mouse 19. By sequentially adding up the amounts of movement of the mouse, the microcomputer 170 calculates the coordinates on the image to which the mouse 19 is pointing. The coordinate data derived in this manner, together with click signals, control signals from the control panel 17 and so on, is output appropriately to the various circuits described hereinbelow.

Via an AFE circuit 112, the image processing circuit 110 inputs the image signal from the camera head 12. Within the camera head 12 are disposed a plurality of lenses including a zoom lens 31 and a focusing lens 33, as well as an iris adjusting mechanism 32 and a CCD 34. The AFE circuit 112 is a circuit for converting the analog signal output from the CCD 34 in the camera head 12 into a digital signal. The image processing circuit 110 sequentially inputs image signals that are from the CCD at a timing of 15 frames per second (15 fps), and stores these in a frame memory 111. Image data is then read from this frame memory at timing of 60 frames per second (60 fps), and is output to the image synthesizing circuit 160. By so doing, the frame rate of images output from the CCD 34 can be converted to a frame rate suitable for display on the display device 18. In the working example, the resolution of images input from the CCD 34 is SXGA (1280×1024 pixels), and the size of the image output to the image synthesizing circuit 160 is SXGA size as well.

In addition to the frame rate conversion function described above, the image processing circuit 110 also comprises a number of other functions such as the function of interpolating CCD pixel data in RGB Bayer array format, the function of enlarging/reducing images in response to commands from the microcomputer 170, the function of adjusting color of images, the function of rotating images, and so on.

The drawing processing circuit 120 carries out drawing of various graphics such as straight lines and curves in a drawing memory 121, with reference to draw commands output by the microcomputer 170, or coordinate data generated and output by the microcomputer 170 in association with movement of the mouse 19. Images drawn in the drawing memory 121 are output to the image synthesizing circuit 160 at timing (60 fps) synchronized with image output by the image processing circuit 110 described above.

The character generating circuit 130 is a circuit for displaying characters such as a pointing marker that moves in tandem with movement of the mouse 19, an eraser pointer, or the like. The character generating circuit 130 comprises a character ROM 131; image data representing characters is stored in this character ROM 131. When a number specifying a class of character for display and coordinate data therefor is input from the microcomputer 170, the character generating circuit 130 generates a 16×16-dot image positioning the specified character at the specified coordinates. The image is then output to the image synthesizing circuit 160 at timing (60 fps) synchronized with image output by the image processing circuit 110.

The OSD generating circuit 140 comprises a graphic ROM 141 in which is stored graphics data of various kinds representing the OSD. When the OSD generating circuit 140 receives from the microcomputer 170 an OSD pattern specification for performing display, it reads out the graphic data for the specified pattern from the graphic ROM. It then generates an image of SXGA size of the graphic, drawn at a predetermined location, and outputs this to the image synthesizing circuit 160 at timing (60 fps) synchronized with image output by the image processing circuit 110.

The mouse cursor generating circuit 150, upon inputting from the microcomputer 170 a signal specifying the color of the mouse cursor MC and coordinate data, generates an image of 32×32-dot size positioning a mouse cursor MC of the specified color at the specified coordinates. This image is then output to the image synthesizing circuit 160 at timing (60 fps) synchronized with image output by the image processing circuit 110.

The image synthesizing circuit 160 synthesizes images output from the circuits described above. The order of priority in synthesis is as follows, in ascending order of priority. According to this order, the OSD and the mouse cursor are displayed superimposed on an image recorded by the camera head 12.
(1) images output from the image processing circuit 110.
(2) images output from the drawing processing circuit 120.
(3) images output from the character generating circuit 130.
(4) images output from the OSD generating circuit 140.
(5) images output from the mouse cursor generating circuit 150.

The image synthesized by the image synthesizing circuit 160 is output to a video DAC 180. The video DAC 180 converts the digital signal output from the image synthesizing circuit 160 into an analog RGB signal. The analog signal converted by the video DAC 180 is used during display of images on a liquid crystal display, CRT, projector, or the like.

The analog signal output by the video DAC 180 is then down-converted by a scan converter 190, and converted into an NTSC signal or PAL signal. These signals are used for outputting images to a television or video recorder.

C. OSD Modes:

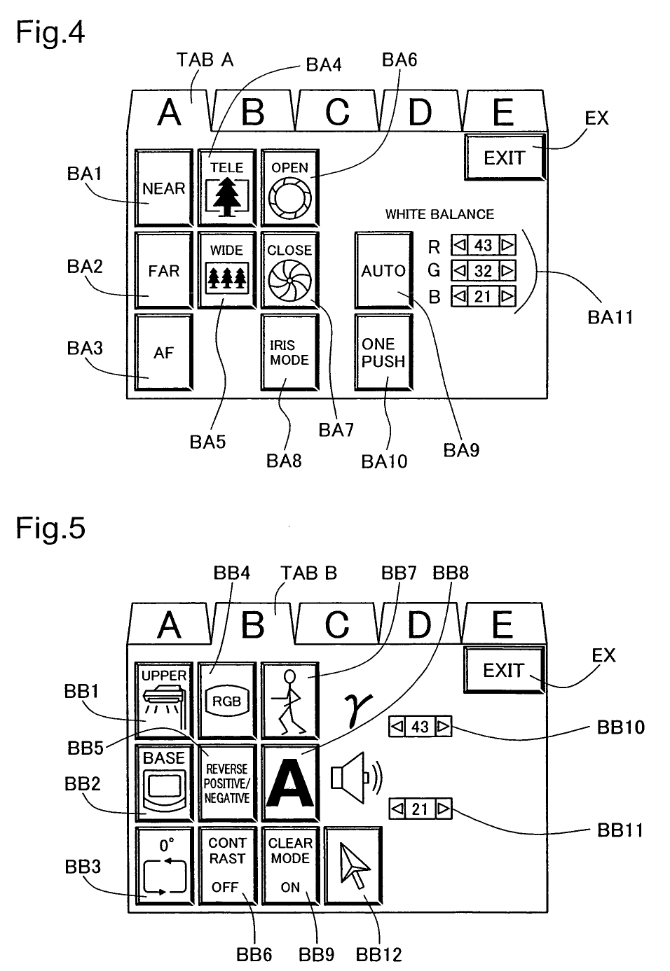

Various OSD modes displayed by the OSD generating circuit are shown in FIG. 4-FIG. 8. As shown in FIG. 2, the OSD has tabs A-E, and by clicking on any tab with the mouse in order to select it, various patterns of OSD classified according to function can be displayed.

FIG. 4 is an illustration showing an OSD that organizes functions for carrying out camera-related adjustments. This OSD is displayed by selecting Tab A. In this OSD there are provided buttons BA1, BA2 for adjusting focus, a button BA3 for automatically bringing into focus, buttons BA4, BA5 for adjusting zoom, buttons BA6, BA7 for adjusting the iris, and a button BA8 for switching between automatic adjustment and manual adjustment of the iris. By pressing these buttons, the microcomputer 170 controls the camera head 12 to adjust the position of the focus lens 33 or zoom lens 31 on the optical axis, and to adjust the opening of the iris adjustment mechanism 32 (see FIG. 3).

The OSD is additionally provided with a button BA9 for automatically adjusting the white balance, a button B10 for locking in the white balance by depressing the button, and a button set BA11 for adjusting white balance manually. By operating these buttons, the microcomputer 170 controls the image processing circuit 110 in order to adjust the white balance of the image.

FIG. 5 is an illustration showing an OSD that organizes functions relating to control of lighting and to image processing. This OSD is displayed by selecting Tab B. In this OSD there are provided a button BB1 for switching lights 13, 14 on and off, and a button BB2 for switching light 15 on and off. When these buttons are pressed, the microcomputer 170 switches the specified light on or off.

In this OSD there have also been provided a button BB3 for rotating the image, a button BB4 for switching between color/black-and-white, a button BB5 for switching between positive/negative, a button BB6 for switching contrast settings, a button BB7 for pausing a displayed image, a button BB8 for switching edge contrast, a button BB9 for switching modes in order to improve S/N ratio of the image, and a button set BB10 for setting image gamma value. When these buttons are operated, the microcomputer 170 controls the image processing circuit 110 to carry out the desired image processing.

In this OSD there is further provided a button set BB11 for adjusting the volume of sound output via the Audio Out terminal of the document presentation device 10. Also provided in the OSD is a button BB12 for changing the color or shape of the mouse cursor MC. Each time that this button is pressed, the mouse cursor MC cycles through white arrow ? blue arrow ? yellow arrow ? red arrow ? white line ? blue line ? yellow line ? red line. When the microcomputer 170 detects that this button BB12 has been pressed, it outputs to the mouse cursor generating circuit 150 a signal specifying the shape and color of the cursor.

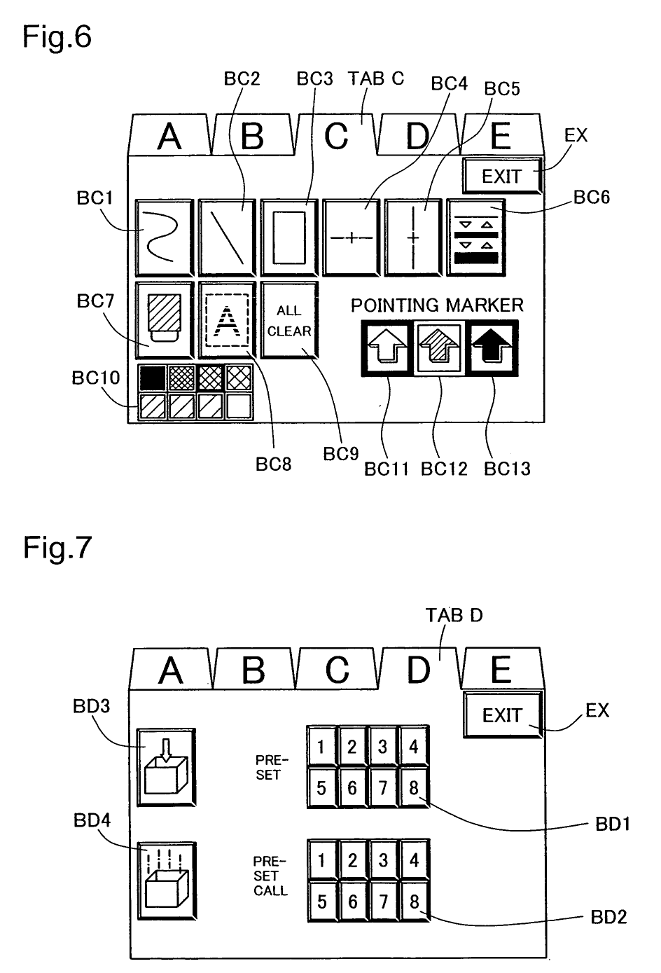

FIG. 6 is an illustration showing an OSD that organizes functions for carrying out drawing of graphics and positioning of pointing markers. This OSD is displayed by selecting Tab C. In this OSD there are provided a button BC1 for drawing a line freehand, a button BC2 for drawing a straight line, a button BC3 for drawing a box, a button BC4 for drawing a horizontal extension line, a button BC5 for drawing a vertical extension line, a button BC6 for changing line thickness, a button BC7 for deleting any drawn part, a button BC8 for deleting graphics within any rectangular area, a button BC9 for deleting all graphics, and a color palette BC10 for specifying color in which graphics will be drawn. When these buttons are pressed, the microcomputer 170 appropriately outputs draw commands, coordinate data and so on to the drawing processing circuit 120. Of these buttons, in the event that button BC7 is pressed, the microcomputer 170 performs a process to control the mouse cursor generating circuit 150 to delete the mouse cursor MC, and to control the character generating circuit 130 in order to display the Eraser pointer at the location at which the mouse cursor MC is to be displayed.

Also provided in this OSD are marker buttons BC11-13 for positioning the pointing markers PM1-PM3 shown in FIG. 2 on the image. The pointing markers are provided in three colors, namely, red, blue and green; the user can select a pointing marker of any color from among these. When a pointing marker to be positioned is selected by operating the mouse 19, the border around the pointing marker is shown in white. The process for positioning the pointing marker will be described in detail later. While here a plurality of pointing markers of different colors are provided, a plurality of pointing markers of different shapes could be provided as well. The color of a pointing marker may be modifiable by means of a predetermined operation.

FIG. 7 is an illustration showing an OSD that organizes functions for saving settings of the document presentation device 10. This OSD is displayed by selecting Tab D. In this OSD there are provided preset buttons BD1 for saving various parameters such as zoom, focus, and color, and call buttons BD2 for calling up the saved parameters. Also provided are a button BD3 for storing values of parameters set when the power is turned on, and a button BD4 for restoring parameters to their factory settings. The preset buttons BD1 are composed of eight buttons, each button being individually assigned to save a parameter. When a preset button BD1 is pressed, the microcomputer 170 records the current set parameter in an area assigned to the button in EEPROM 173. When a call button BD2 is pressed, the parameter stored in the area assigned to the button in EEPROM 173 is read out, and various settings to the camera head 12 and image processing circuit 110 are made with reference to the read out parameter.

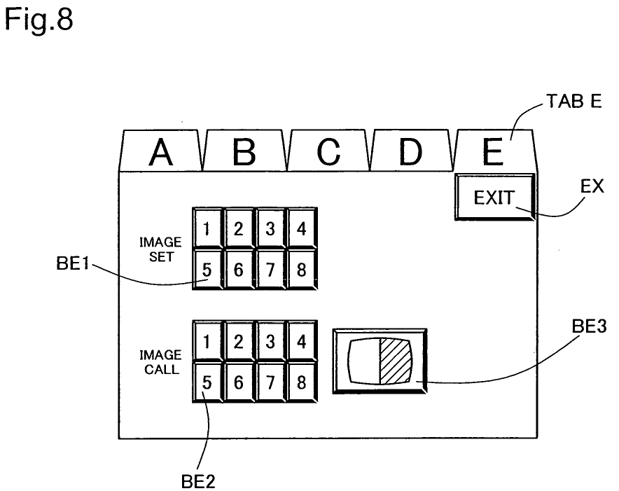

FIG. 8 is an illustration showing an OSD that organizes functions for saving images. This OSD is displayed by selecting Tab E. In this OSD there are provided save buttons BE1 for saving images recorded by the camera head 12, and read buttons BE2 for reading out saved images. The save buttons BE1 are composed of eight buttons for individually saving up to eight images. When a save button BE1 is pressed, the image is saved in a predetermined area in the frame memory 111 corresponding to the button number. When a read button BE2 is pressed, the image is read from the predetermined area in the frame memory 111 corresponding to the pressed button. The read out image is output to the display device 18 by the image processing circuit 110. The image could be saved in RAM 172, EEPROM 173, or some separately provided flash memory or the like in the document presentation device 10, rather than in the frame memory 111. In the OSD is also provided a split-screen button BE3 for simultaneously displaying in a split screen an image read from the frame memory 111 by the read button BE2, and an image capture by the camera head 12, so that the two can be compared.

The various OSD menus described above each have a button EX labeled “EXIT” located in the upper right corner. When the button EX is pressed, the microcomputer 170 controls the OSD generating circuit and cancels the OSD.

D. Mouse Cursor and OSD Display Procedure:

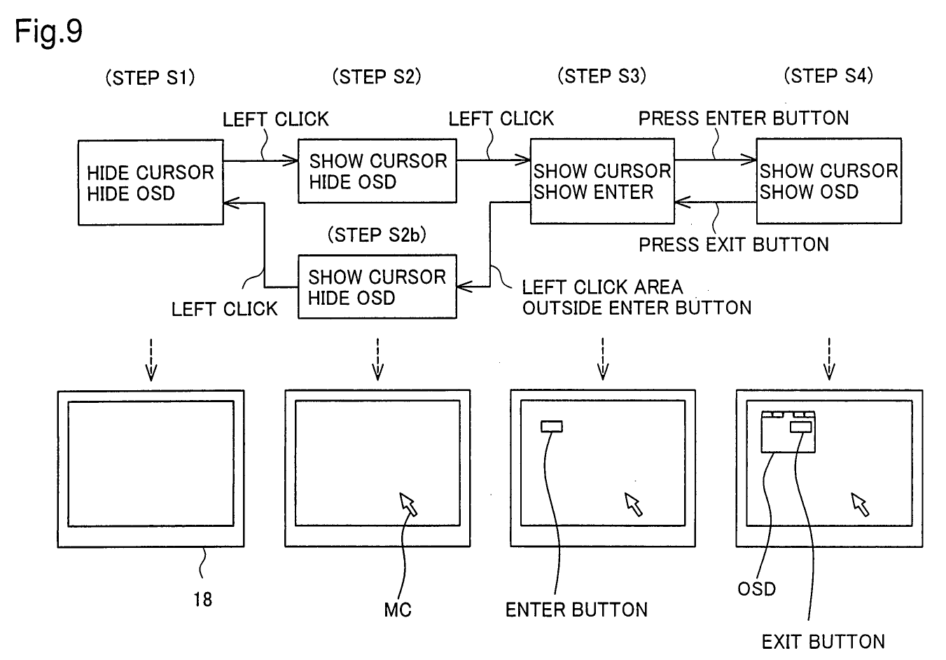

FIG. 9 is an illustration showing the procedure for displaying the mouse cursor MC and the OSD. Immediately after the document presentation device 10 has been started up, the display device 18 displays only the image being captured by the camera head 12. At this time, the mouse cursor MC and the OSD are in hidden mode (step S1). In this state, if a left click operation of the mouse 19 is detected, the microcomputer 170 controls the mouse cursor generating circuit 15 and displays the mouse cursor MC on the display device 18 (step S2). In this state, if another left click operation is detected, the microcomputer 170 controls the OSD circuit 140 and displays an ENTER button at a predetermined location on the display device 18 (step S3). In this state, if pressing of the ENTER button by a mouse 19 operation is detected, the microcomputer 170 controls the OSD circuit 140 and displays the OSD on the display device 18 (step S4).

Next, if it is detected that the EXIT button provided on each OSD tab has been pressed, the microcomputer 170 cancels the OSD and performs display of the ENTER button (step S3). In this state, if the ENTER button is pressed, OSD display is performed again (step S4). If a mouse 19 left click operation in an area outside the ENTER button is detected the microcomputer 170 cancels the ENTER button (step S2b). In this state, if another left click operation is detected, the mouse cursor MC is canceled (step S1). In this case, only the image being captured by the camera head 12 will be displayed.

E. Pointing Marker Positioning Process:

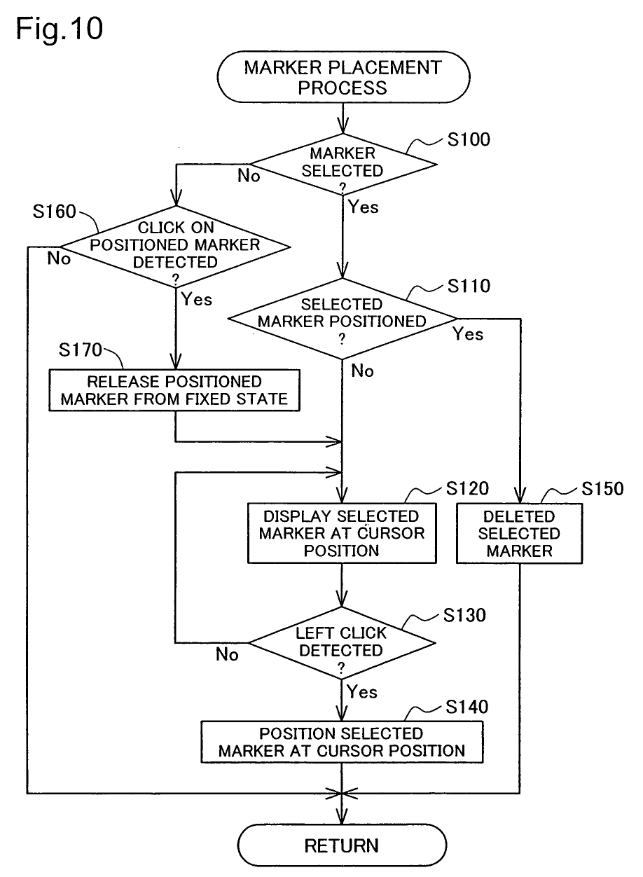

Following is a description of the process for positioning the pointing markers PM1-PM3 shown in FIG. 2. FIG. 10 is a flowchart of the process executed by a microcomputer 170 during positioning of a pointing marker. The process is executed in the OSD display mode shown in FIG. 6.

First, the microcomputer 170 detects depressing of a marker button BC11-13 (see FIG. 6) provided on Tab C of the OSD, to determine if any pointing marker has been selected from among the pointing markers PM1-PM3 (step S100). If it is determined that a pointing marker has been selected (step S100: Yes), next, a determinations is made as to whether the selected pointing marker is already positioned on the image (step S110). This determination can be made on the basis of whether coordinates of the pointing marker are already stored in memory in a predetermined area of RAM 172, described later. If not already positioned (step S110: No), the selected pointing marker is displayed at the same location as the mouse cursor MC (step S120). Specifically, together with the number specifying the type of selected pointing marker, coordinate data identical to the coordinate data output from the microcomputer 170 to the mouse cursor generating circuit 150 is output to the character generating circuit 130. By so doing, the pointing marker selected from the OSD is displayed at the same location as the mouse cursor MC.

Next, the microcomputer 170 detects whether a left click operation has been performed with the mouse 19 (step S130), and if a left click operation is detected (step S130: Yes), the pointer marker is positioned at the current position of the mouse cursor MC (step S140). Specifically, the coordinates of the mouse cursor MC are recorded in RAM 172 at timing coincident with detection of a left click operation by the mouse 19. Together with these coordinates, a number representing the type of selected pointing marker is normally output to the character generating circuit 130. As noted, since the character generating circuit 130 carries out display of the specified pointing marker at specified coordinates, the pointing marker is displayed at a fixed location on the image by means of this process. In RAM 172 are established individual areas for storing coordinates for different pointing marker types. Thus, each pointing marker can be placed individually at different coordinates. In the aforementioned Step S130, in the event that no left click operation is detected (step S130: No), the process returns to Step S120. By so doing, the pointing marker moves in conjunction with movement of the mouse cursor MC.

In the aforementioned Step S110, in the event of a determination that the pointing marker has already been positioned (step S110: Yes), the microcomputer 170 cancels the pointing marker (step S150).

In the aforementioned Step S100, in the event of a determination that no pointing marker has been selected (step S100: No), the microcomputer 170 detects whether a left click operation of the mouse 19 has been performed with the mouse cursor MC superimposed over the previously positioned pointing marker (step S160). The determination as to whether the pointing marker and the mouse cursor MC are superimposed can be made by comparing the coordinates stored in RAM 172 in the aforementioned Step S140 with the coordinates of the mouse cursor MC. In the event that a left click is detected in this state (step S160: Yes), the pointing marker is released from its fixed state by means of deleting the coordinates stored in RAM 172 in the aforementioned Step S140 (step S170), and moving to the aforementioned Step S120. By so doing, the pointing marker is again displayed at the same location as the mouse cursor MC, and the location for placement of the pointing marker can be reset.

The microcomputer 170 executes the process described above as a constantly running loop. According to the process described above, a pointing marker selected by an operation from the OSD can be positioned at any location on the screen. Even after a pointing marker has been positioned, it is possible to easily move the pointing marker to another location. Additionally, since the pointing markers PM1-PM3 can be positioned individually at arbitrary locations by means of this process, the pointing markers can be used selectively according to application.

The arrangement and processes of the document presentation device 10 of the working example have been described hereinabove. According to the document presentation device 10 of the working example, any location on an image can be indicated by a pointing marker, not just the mouse cursor MC. Accordingly, even if the mouse cursor MC needs to be moved in order to carry out an operation from the OSD, the location on the image can continue to be pointed out by the pointing marker, so that the presentation can be carried out favorably. According to the working example, a pointing marker can be positioned easily by and operation using the OSD and mouse 19. It is accordingly possible to provide a document presentation device 10 with outstanding ease of operation.

As shown in FIG. 2, the pointing marker of the working example has the shape of an arrow pointing upward, but the direction in which the arrow points is arbitrary. For example, it could point downward, or to the left or right. It may also point in the same direction as the mouse cursor MC. Alternatively, the orientation can be modifiable by means of a predetermined operation. The shape of the pointing marker is not limited to an arrow shape. For example, it could be a cross shape, or a circular shape. The color of the pointing marker is arbitrary as well. In this case, color could be made settable by means of a predetermined OSD, with the color of pointing markers being modifiable appropriately once positioned.

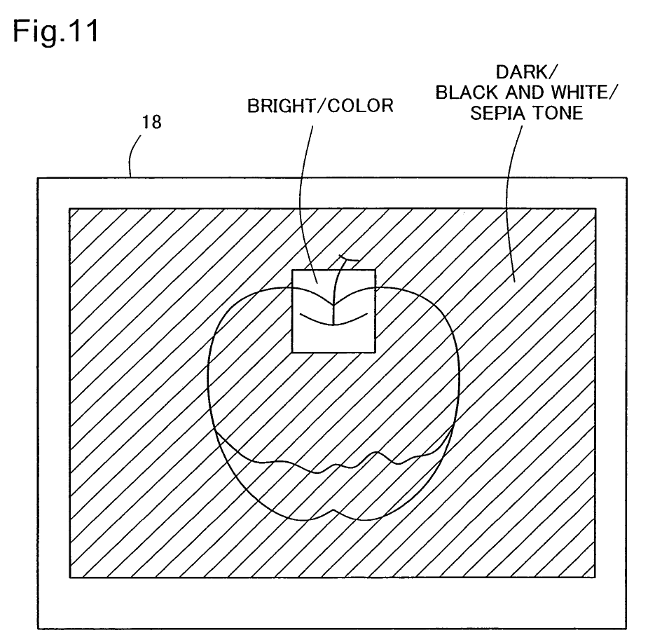

In the working example an arrow shaped pointing marker is displayed on the display device 18; however, a function analogous to that of a pointing marker could be realized by means of a display in which the color of the area around the location where the pointing marker is to be positioned is different from the color of other areas. With such an arrangement, there could be employed an embodiment such as that depicted in FIG. 11 for example, where the brightness of the area around the location where the pointing marker is to be positioned is relatively brighter than brightness of other areas; or an embodiment in which the area around the location where the pointing marker is to be positioned is displayed in color, while other areas are displayed in black and white or in sepia tone. By means of such an arrangement, any location on an image can be highlighted in display, without the image positioned underlying being hidden by placement of the pointing marker, so that the presentation can be carried out favorably.

In the working example, display of the pointing marker is carried out by the character generating circuit 130. However, an arrangement whereby the pointer is rendered in the frame memory 111 by having the microcomputer 170 output image data representing a pointing marker to the image processing circuit 110 would also be possible. Alternatively, an arrangement whereby\the pointer is rendered in the frame memory 111 by similar image data is output to the drawing processing circuit 120 would also be possible. With either of these arrangements, a pointing marker can be displayed superimposed on the final image.

Having described a preferred embodiment of the invention with reference to the accompanying drawings, it is to be understood that the invention is not limited to the embodiments and that various changes and modifications could be effected therein by one skilled in the art without departing from the spirit or scope of the invention as defined in the appended claims.

1. A presentation device for displaying, on a connected display device, an image created by recording a document, the presentation device comprising:
operation detecting unit that detects operation of a pointing device intended to point to any particular location on an image displayed on the display device;
cursor display unit that displays on the image a cursor that moves in response to movement of the pointing device; and
marker positioning unit that, on the basis of a predetermined operation performed at a location being pointed to by the cursor on the image, positions a stationary predetermined marker of predetermined form.

2. A presentation device according to claim 1, wherein said cursor display unit displays said marker together with said moving cursor, until said predetermined operation is detected.

3. A presentation device according to claim 1 or 2, wherein said marker positioning unit deletes said positioned marker, on the basis of a specified operation.

4. A presentation device according to claim 1, wherein said marker positioning unit comprises marker selecting unit that, prior to positioning of said marker, selects said predetermined marker from among a plurality of markers of different types prepared in advance.

5. A presentation device according to claim 1, wherein said marker positioning unit positions said marker by changing the color of a predetermined area in the image that includes the location pointed to by said cursor, to a color different from that of other areas.

6. A display method for displaying an image, said method comprising the steps of:
recording materials to generate said image;
displaying said image on a display device;
detecting operation of a pointing device in order to point to any location on the image displayed on said display device;
displaying on said image a cursor that moves in accordance with movement operations using said pointing device; and
on the basis of a predetermined operation, positioning a fixed predetermined marker of predetermined form at the location on said image pointed to by said cursor.
